(19) United States
(12) Patent Application Publication
(10) Pub. No.: US 2022/0245811 A1
(43) Pub. Date: Aug. 4, 2022

(54) ANALYSIS OF RETINAL IMAGING USING VIDEO

(71) Applicant: AI Optics Inc., New York, NY (US)

(72) Inventors: Andrew DiGiore, New York, NY (US); Luke Michael Moretti, New York, NY (US); Sayed Mazdak Abulnaga, Somerville, MA (US); Benjamin JJ Villard, Bethesda, MD (US)

(21) Appl. No.: 17/585,988

(22) Filed: Jan. 27, 2022

Related U.S. Application Data
(60) Provisional application No. 63/144,416, filed on Feb. 1, 2021.

(51) Int. Cl. G06T 7/00

(52) U.S. Cl. CPC G06T 7/0014; G06T 2207/20084; G06T 2207/30041; G06T 2207/20081

(57) ABSTRACT

Systems and methods that can perform real-time, artificial intelligence (AI) analysis of live retinal imaging on a medical diagnostics device are disclosed. In some cases, a retinal diagnostics instrument includes an imaging device configured to capture video data of an eye of a patient and an electronic processing circuitry configured to assess a quality of the video data of the eye of the patient, process the plurality of images of the eye with at least one machine learning model to determine a presence of at least one disease from a plurality of diseases that the at least one machine learning model has been trained to identify, and provide an indication of the presence of the at least one disease.

### CROSS-REFERENCE TO RELATED APPLICATIONS

This application claims priority to U.S. Provisional Application No. 63/144,416 filed on Feb. 1, 2021, which is incorporated by reference in its entirety.

### TECHNICAL FIELD

Disclosed are systems and methods that can perform analysis of videos from live retinal imaging on medical diagnostics devices, for example, using artificial intelligence (AI).

### BACKGROUND

A fundus (or retina) camera is an instrument for inspecting the retina of the eye. Many ophthalmologic, neurologic, and systemic diseases can cause structural abnormalities in the retina, which alter the visual appearance of the retina. These structural and visible abnormalities are known as biomarkers, and they may indicate the presence of a disease. For example, diabetics have high levels of circulating blood sugar that, over time, can cause damage to the small vessels in the retina and lead to the formation of microaneurysms. Such microaneurysms indicate the presence of diabetic retinopathy, which is a diabetes complication that affects eyes, caused by damage to the blood vessels of the light-sensitive tissue at the retina. Clinicians use fundus cameras to visualize and assess a patient's retina for biomarkers in order to diagnose the disease.

### SUMMARY

In some implementations, a retinal diagnostics instrument can include a housing and an imaging device, which can be supported by the housing. The imaging device can be configured to capture video data of an eye of a patient. The instrument can include an electronic processing circuitry, which can be supported by the housing. The electronic processing circuitry can be configured to assess a quality of the video data of the eye of the patient. The electronic processing circuitry can be configured to, based on a determination that the quality of the video data satisfies at least one threshold, process a plurality of images of the eye obtained from the video data with at least one machine learning model to determine a presence of at least one disease from a plurality of diseases that the at least one machine learning model has been trained to identify. The electronic processing circuitry can be configured to provide an indication of the presence of the at least one disease.

The diagnostics instrument of the preceding paragraph or any of the diagnostics instruments disclosed herein can include one or more of the following features. The plurality of images of the eye of the patient may be processed without requiring a user to capture the plurality of images. The electronic processing circuitry can be configured to assess the quality of the video data based on an assessment of quality of one or more frames of the video data. The electronic processing circuitry can be configured to assess the quality of the video data based on the assessment of quality of a group of frames of the video data. The plurality of images can include one or more frames of the group of frames whose quality had been determined to satisfy the at least one threshold. The electronic processing circuitry can be configured to assess the quality of the video data based on the assessment of each frame of the group of frames of the video data. The plurality of images can include one or more frames whose quality had been determined to satisfy the at least one threshold.

The diagnostics instrument of any of the preceding paragraphs or any of the diagnostics instruments disclosed herein can include one or more of the following features. The instrument can include a display, which can be at least partially supported by the housing. The electronic processing circuitry can be configured to cause the display to display at least one of the video data or the plurality of images. The electronic processing circuitry can be configured to cause the display to display an indication of the determination that the quality of the video data satisfies the at least one threshold. The electronic processing circuitry can be configured to cause the display to provide an indication of the presence of the at least one disease. The display can be a touch screen display.

The diagnostics instrument of any of the preceding paragraphs or any of the diagnostics instruments disclosed herein can include one or more of the following features. Assessment of the quality of the video data of the eye of the patient can include determining one or more of image quality of the video data or presence of an anatomical structure of interest in the video data. Assessment of the image quality of the video data can include assessment of at least one of: focus, brightness, contrast, presence of one or more aberrations or reflections, or anatomic location. Determination of the presence of disease can be done by treating each frame of the video independently, selecting a number of frames, or processing frames with information of the previous frames. The presence of disease can contain a measure of uncertainty based on the presence of a number of characteristic features in several frames. The imaging device can be a camera. The instrument can include a cup positioned at a distal end of the housing. The cup can be configured to be an interface between instrument and the eye of the patient. The cup can be disposable. The housing can include a body and a handle connected to the body and configured to be held by a user. The housing can be portable.

A method of operating the instrument of any of the preceding paragraphs or any of the instruments disclosed herein is provided.

### BRIEF DESCRIPTION OF DRAWINGS

Throughout the drawings, reference numbers may be re-used to indicate correspondence between referenced elements. The drawings are provided to illustrate example embodiments described herein and are not intended to limit the scope of the disclosure.

FIG. 1 illustrates retina camera.

FIG. 2 schematically illustrates a system level diagram showing retina camera components of FIG. 1.

FIG. 3 illustrates a flow chart of a process for image analysis.

### DETAILED DESCRIPTION

### Introduction

Current trends for using artificial intelligence (AI) to detect features in one or more images tend to require performing the analysis using cloud-based processing, which necessitates connectivity for transferring data. Known retinal analysis systems tend to rely on the use of static photographs or images. For example, a static retinal image can be obtained, the single image can be analyzed using various techniques, and output can be generated. However, when using cloud-based solutions, potential interruptions of the clinical workflow may occur due to network connectivity issues. Further, for certain disease types, a snapshot at one point in time may be missing key features necessary for disease classification. In imaging the retina, an individual image may not capture the entire field of view, and therefore multiple images may be required, which can potentially compound errors. Moreover, when images have a relationship with each other, such as time dependence, the use of individual images for analysis often forgoes this information. This results in an AI model having to learn specific features of interest based on singular entities, and thus potentially decreasing or limiting the performance of the system.

In addition, obtaining a high-quality image can be important to ensure performance of the system. Since a user or operator (such as, a clinician) imaging techniques and abilities may vary significantly when capturing retinal images, it may take multiple static image capture attempts before a sufficient quality retinal image is attained. The process of retaking or reattempting images can be both tedious and frustrating, as it is necessary to reposition and refocus the camera onto the retina.

Disclosed systems and methods generally relate to automatically performing quality assessment and disease detection using one or more videos captured from live imaging of a retina, without the need to capture individual images to assess image quality and perform disease detection. Video can include multiple images (or frames). The frames may be captured at high frequencies (such as, 30 frames per second, 60 frames per second, or the like). AI (or another methodology) can be used to analyze, in real-time, a live video feed captured during a retinal imaging procedure. As is used herein, “real-time” also encompasses processing performed substantially in real-time (such as, with a small delay of 10 milliseconds or less or more, 100 milliseconds or less or more, 500 milliseconds or less or more, 2-5 seconds or less or more). The analysis can be performed in a frame-by-frame manner or on a subset of frames. The AI can analyze for image quality or another image characteristic and, subsequently, for the presence or absence of features, anatomical structures, diseases, or conditions. In some cases, each frame (or selected frames) of a video can be analyzed by the AI in real-time. The assessment can include determining image quality or another image characteristic, such as the presence of anatomic structures (such as, macula, disc, etc.), right or left eye, etc. The image quality assessment may include, but is not limited to, evaluation of focus, noise, motion blur, brightness, presence of aberrations or reflections, contrast, and anatomic location (such as, disc-centered vs. macula-centered). The image quality assessment may use various methodologies to assess quality, including linear models, deep learning, and various filters. For example, the system may automatically pick the least blurry, sharpest image and discard other frames. The system may use information from several frames to correct and produce a high-quality image.

Non-limiting advantages of the disclosed systems and methods can include the ability to assess image quality in real-time, to detect features, characteristics, or diseases in real-time, to improve disease detection by observing features that change over time, or to improve disease detection by observing features in several viewing angles. Image analysis can be improved through reducing image artifacts, improving image quality, and reducing variability by indicating user performance in real-time. Real-time analysis of retinal imaging can be performed and the need to capture still images for future analysis can be eliminated. The use of video (or time-series images), can boost the performance of AI models for multiple tasks, including image quality assessment, visualization, pathology identification, classification, or prediction. Faster procedures, quicker diagnosis, faster identification of features, minimal potential operator error, or more comprehensive screening for diseases and conditions can be facilitated. The retina can be analyzed in real-time as the user is examining the patient. Images can be automatically captured and processed such that there is no need for the user to capture the images manually.

Medical Diagnostics Devices with On-Board AI

A device with integrated artificial intelligence (AI) can be used to assess a patient's body part to detect a disease. The device may be portable or handheld by a user (which may be a patient or a healthcare provider). For example, the device can be a retina camera configured to assess a patient's eye (or retina) and, by using an on-board AI retinal disease detection system, provide real-time analysis and diagnosis of disease that caused changes to the patient's retina. Easy and comfortable visualization of the patient's retina can be facilitated using such retina camera, which can be placed over the patient's eye, display the retina image on a high-resolution display, potentially with screenshot capabilities, analyze a captured image by the on-board AI system, and provide determination of presence of a disease.

Such retina camera can perform data collection, processing, and diagnostics tasks on-board without the need to connect to another computing device or to cloud computing services. This approach can avoid potential interruptions of the clinical workflow when using cloud-based solutions, which involve transfer of data over the network and, accordingly, rely on network connectivity. This approach can facilitate faster processing because the device can continually acquire and process images without needing intermediary upload/download steps, which may be slow. Such retina camera can potentially improve accuracy (for instance, as compared to retina cameras that rely on a human to perform analysis), facilitate usability (for example, because no connectivity is used to transfer data for analysis or transfer results of the analysis), provide diagnostic results in real-time, facilitate security and guard patient privacy (for example, because data is not transferred to another computing device), or the like. Such retina camera can be used in many settings, including places where network connectivity is unreliable or lacking.

Such retina camera can allow for better data capture and analysis, facilitate improvement of diagnostic sensitivity and specificity, and improve disease diagnosis in patients. Existing fundus cameras may lack one or more of portability, display, on-board AI capabilities, etc. or require one or more of network connectivity for sharing data, another device (such as, mobile phone or computing device) to view collected data, rigorous training of the user, etc. In contrast, allowing for high-quality retinal viewing and image capturing with faster analysis and detection of the presence of disease via on-board AI system and image-sharing capabilities, the retina cameras described herein can potentially provide improved functionality, utility, and security. Such retina camera can be used in hospitals, clinics, and/or at home. The retina cameras or other instruments described herein, however, need not include each of the features and advantages recited herein but may possibly include any individual one of these features and advantages or may alternatively include any combination thereof.

As another example, the device can be an otoscope configured to assess a patient's ear and, by using an on-board artificial intelligence (AI) ear disease detection system, possibly provide immediate analysis and/or diagnosis of diseases of the patient's ear. Such an otoscope can have one or more advantages described above or elsewhere in this disclosure. As yet another example, the device can be a dermatology scope configured to assess a patient's skin and, by using an on-board artificial intelligence (AI) skin disease detection system, possibly provide immediate analysis and/or diagnosis of diseases of the patient's skin. Such a dermatology scope can have one or more advantages described above or elsewhere in this disclosure.

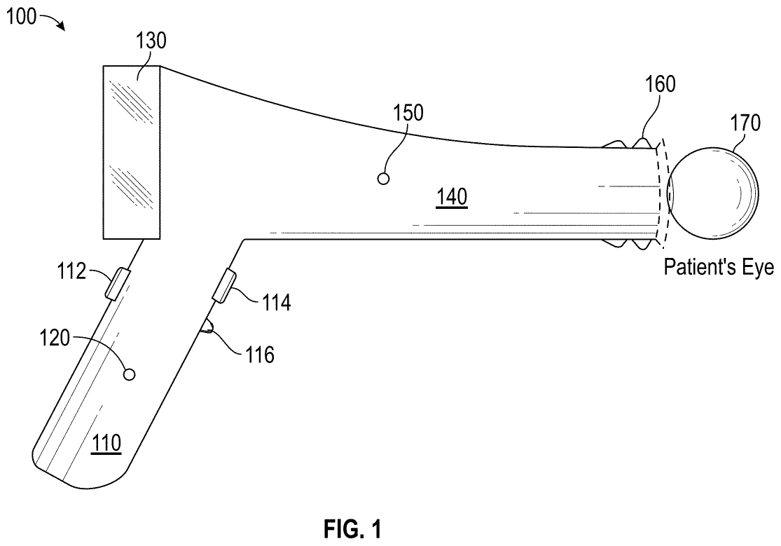

FIG. 1 illustrates an example retina camera 100. A housing of the retina camera 100 can include a handle 110 and a body 140 (in some cases, the body can be barrel-shaped). The handle 110 can optionally support one or more of power source, imaging optics, or electronics 120. The handle 110 can also possibly support one or more user inputs, such as a toggle control 112, a camera control 114, an optics control 116, or the like. Toggle control 112 may be used to facilitate operating a display 130 in case of a malfunction. For example, toggle control 112 can facilitate manual scrolling of the display, switching between portrait or landscape mode, or the like. Toggle control 112 can be a button. Toggle control 112 can be positioned to be accessible by a user's thumb. Camera control 114 can facilitate capturing video or an image. Camera control 114 can be a button. Camera control 114 can be positioned to be accessible by a user's index finger (such as, to simulate action of pulling a trigger) or middle finger. Optics control 116 can facilitate adjusting one or more properties of imaging optics, such as illumination adjustment, aperture adjustment, focus adjustment, zoom, etc. Optics control 116 can be a button or a scroll wheel. For example, optics control 116 can focus the imaging optics. Optics control 116 can be positioned to be accessible by a user's middle finger or index finger.

The retina camera 100 can include the display 130, which can be a liquid crystal display (LCD) or other type of display. The display 130 can be supported by the housing as illustrated in FIG. 1. For example, the display 130 can be positioned at a proximal end of the body 140. The display 130 can be one or more of a color display, high resolution display, or touch screen display. The display 130 can reproduce one or more images of the patient's eye 170. The display 130 can allow the user to control one or more image parameters, such as zoom, focus, or the like. The display 130 (which can be a touch screen display) can allow the user to mark whether a captured image is of sufficient quality, select a region of interest, zoom in on the image, or the like. Any of the display or buttons (such as, controls, scroll wheels, or the like) can be individually or collectively referred to as user interface. The body 140 can support one or more of the power source, imaging optics, imaging sensor, electronics 150 or any combination thereof.

A cup 160 can be positioned on (such as, removably attached to) a distal end of the body 140. The cup 160 can be made at least partially from soft and/or elastic material for contacting patient's eye orbit to facilitate examination of patient's eye 170. For example, the cup can be made of plastic, rubber, rubber-like, or foam material. Accordingly, the cup 160 may be compressible. The cup 160 can also be disposable or reusable. In some cases, the cup 160 can be sterile. The cup 160 can facilitate one or more of patient comfort, proper device placement, blocking ambient light, or the like. Some designs of the cup may also assist in establishing proper viewing distance for examination of the eye and/or pivoting for panning around the retina.

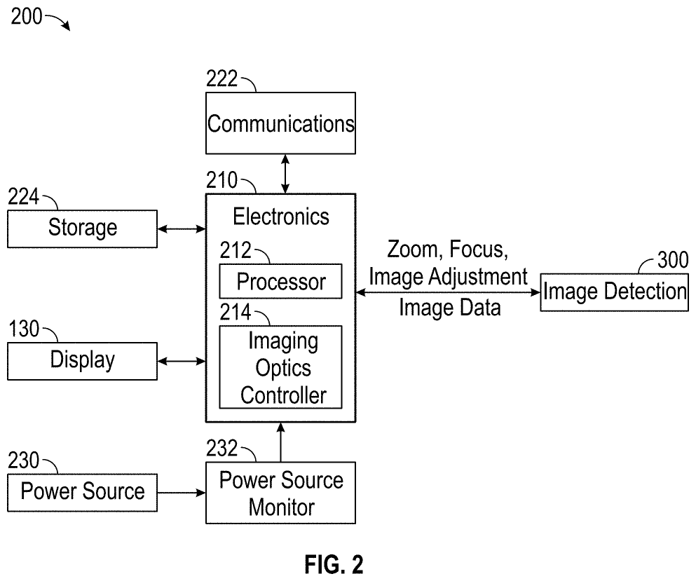

FIG. 2 illustrates a block diagram 200 of various components of the retina camera 100. Power source 230 can be configured to supply power to electronic components of the retina camera 100. Power source 230 can be supported by the handle 110, such as positioned within or attached to the handle 110 or be placed in another position on the retina camera 100. Power source 230 can include one or more batteries (which may be rechargeable). Power source 230 can receive power from a power supply (such as, a USB power supply, AC to DC power converter, or the like). Power source monitor 232 can monitor level of power (such as, one or more of voltage or current) supplied by the power source 230. Power source monitor 232 can be configured to provide one or more indications relating to the state of the power source 230, such as full capacity, low capacity, critical capacity, or the like. One or more indications (or any indications disclosed herein) can be visual, audible, tactile, or the like. Power source monitor 232 can provide one or more indications to electronics 210.

Electronics 210 can be configured to control operation of the retina camera 100. Electronics 210 can include one or more hardware circuit components (such as, one or more controllers or processors 212), which can be positioned on one or more substrates (such as, on a printed circuit board). Electronics 210 can include one or more of at least one graphics processing unit (GPU) or at least one central processing unit (CPU). Electronics 210 can be configured to operate the display 130. Storage 224 can include memory for storing data, such as image data obtained from the patient's eye 170, one or more parameters of AI detection, or the like. Any suitable type of memory can be used, including volatile or non-volatile memory, such as RAM, ROM, magnetic memory, solid-state memory, magnetoresistive random-access memory (MRAM), or the like. Electronics 210 can be configured to store and retrieve data from the storage 224.

Communications system 222 can be configured to facilitate exchange of data with another computing device (which can be local or remote). Communications system 222 can include one or more of antenna, receiver, or transmitter. In some cases, communications system 222 can support one or more wireless communications protocols, such as WiFi, Bluetooth, NFC, cellular, or the like. In some instances, the communications system can support one or more wired communications protocols, such as USB. Electronics 210 can be configured to operate communications system 222. Electronics 210 can support one or more communications protocols (such as, USB) for exchanging data with another computing device.

Electronics 210 can control an image detection system 300, which can be configured to facilitate capturing of (or capture) image data of the patient's eye 170. Electronics 210 can control one or more parameters of the image detection system 300 (for example, zoom, focus, aperture selection, image capture, provide image processing, or the like). Such control can adjust one or more properties of the image of the patient's eye 170. Electronics 210 can include an imaging optics controller 214 configured to control one or parameters of the image detection system 300. Imaging optics controller 214 can control, for example, one or more motor drivers of the image detection system 300 to drive motors (for example, to select an aperture, to select lenses that providing zoom, to move of one or more lenses to provide autofocus, to move a detector array 380 or image sensor to provide manual focus or autofocus, or the like). Control of one or more parameters of the image detection system 300 can be provided by one or more of user inputs (such as a toggle control 112, a camera control 114, an optics control 116, or the like), display 130, etc. Image detection system 300 can provide image data (which can include one or more images) to electronics 210. As disclosed herein, electronics 210 can be supported by the retina camera 100. Electronics 210 may not be configured to be attached to (such as, connected to) another computing device (such as, mobile phone or server) to perform determination of presence of a disease.

### Disease Identification Through Image Analysis

Electronics 210 can include one or more controllers or processors (such as, a processor 212), which can be configured to analyze one or more images to identify a disease. For example, electronics 210 can include a processing system (such as, a Jetson Nano processing system manufactured by NVIDIA or a Coral processing system manufactured by Google), a System-on-Chip (SoC), or a Field-Programmable Gate Array (FPGA) to analyze one or more images. One or more images (or photographs) or video can be captured, for example, by the user operating the camera control 114 and stored in the storage 224. One or more prompts can be output on the display 130 to guide the user (such as, “Would you like to capture video or an image?”). Additionally or alternatively, symbols and graphics may be output on the display 130 to guide the user. Image quality can be verified before or after processing the one or more images or storing the one or more images in the storage 224. If any of the one or more images is determined to be of poor quality (for instance, as compared to a quality threshold), the image may not be processed or stored, the user can be notified, or the like. Image quality can be determined based on one or more of brightness, sharpness, contrast, color accuracy, distortion, noise, dynamic range, tone reproduction, or the like.

One or more preset modes can facilitate easy and efficient capture of multiple images or video. Such one or more preset modes can automatically focus, capture, verify image quality, and store the video or image(s). For some designs the one or more preset modes can switch one or more settings (such as, switch the light source to infrared light), and repeat this cycle without user intervention. In some designs, for example, a preset mode can facilitate obtaining multiple images for subsequent analysis. Such multiple images, for example, can be taken from different angles, use different light sources, or the like. This feature can facilitate automatically collecting an image set for the patient.

The user can select a region of an image for analysis, for instance, by outlining the region on the touch screen display 130, zooming in on region of interest on the display 130, or the like. In some cases, by default the entire image may be analyzed.

One or more machine learning models (sometimes referred to as AI models) can be used to analyze one or more images or video. One or more machine learning models can be trained using training data that includes images or video of subjects having various diseases of interest, such as retina disease (retinopathy, macular degeneration, macular hole, retinal tear, retinal detachment, or the like), ocular disease (cataracts or the like), systemic disease (diabetes, hypertension, or the like), Alzheimer's disease, etc. For example, any of the machine learning models can include a convolution neural network (CNN), decision tree, support vector machine (SVM), regressions, random forest, or the like. One or more machine learning models processing such images or videos can be used for tasks such as classification, prediction, regression, clustering, reinforcement learning, dimensionality reduction. Training of one or more models can be performed using many annotated images or video (such as, thousands of images or videos, tens of thousands of images or videos, hundreds of thousands of images or videos, or the like). Training of one or more models may be performed external to the retina camera 100. Parameters of trained one or more machine learning models (such as, model weights) can be transferred to the retina camera, for example, via retina camera's wireless or wired interface (such as, USB interface). Parameters of one or more models can be stored in the storage 224 (or in another memory of electronics 210). Output of the analysis (sometimes referred to as a diagnostic report) can include one or more of determination of the presence of disease(s), severity of disease(s), character of disease(s), clinical recommendation(s) based on the likelihood of presence or absence of disease(s). A diagnostic report can be displayed on the display 130. The diagnostic report can be stored in electronic medical record (EMR) format, such as EPIC EMR, or other document format (for example, PDF). The diagnostic report can be transmitted to a computing device. In some cases, the diagnostic report but not image data can be transmitted to the computing device, which can facilitate compliance with applicable medical records regulations (such as, HIPPA, GDPR, or the like).

One or more machine learning models can determine the presence of a disease based on the output of one or more models satisfying a threshold. As described herein, images or videos can be analyzed by one or more machine learning models one at a time or in groups to determine presence of the disease. For instance, the threshold can be 90%. When images are analyzed one at a time, determination of presence of the disease can be made in response to output of one or more models satisfying 90%. When images are analyzed in a group, determination of presence of the disease can be made in response to combined outputs of one or more models analyzing the group of images satisfying 90%.

The user can provide information (or one or more tags) to increase accuracy of the analysis by one or more machine learning models. For example, the user can identify any relevant conditions, symptoms, or the like that the patient (and/or one or more patient's family members) has been diagnosed with or has experienced. Relevant conditions can include systemic disease, retinal disease, ocular disease, or the like. Relevant symptoms can include blurry vision, vision loss, headache, or the like. Symptom timing, severity, or the like can be included in the identification. The user can provide such information using one or more user interface components on the display 130, such as a drop-down list or menu. One or more tags can be stored along with one or more pertinent images in the storage 224. One or more tags can be used during analysis by one or more machine learning models during analysis and evaluation. One or more images along with one or more tags can be used as training data.

In some cases, the diagnostic report may alternatively or additionally provide information indicating increased risk of disease or condition for a physician's (such as, ophthalmologist's) consideration or indicating the presence (or absence) of disease of condition. Physician can use this information during subsequent evaluation of the patient. For example, the physician can perform further testing to determine if one or more diseases are present.

Image or video analysis, including the application of one or more machine learning models to one or more images or video, can be performed by execution of program instructions by a processor and/or by a specialized integrated circuit that implements the machine learning model in hardware.

Disclosed devices and methods can, among other things, make the process of retinal assessment comfortable, easy, efficient, and accurate. Disclosed devices and methods can be used in physician offices, clinics, emergency departments, hospitals, in telemedicine setting, or elsewhere. Unnecessary visits to a specialist healthcare provider (such as, ophthalmologist) can be avoided, and more accurate decisions to visit a specialist healthcare provider can be facilitated. In places where technological infrastructure (such as, network connectivity) is lacking, disclosed devices and methods can be used because connectivity is not needed to perform the assessment.

### Video Capture and Analysis

In an example, every frame in a retinal video feed can be analyzed. In real-time, each frame may be fed through the image quality assessment and, subsequently, through a feature, disease, or condition detection (which can be implemented as one or more AI models). As another example, selected frames can be analyzed. The frames may be selected by taking into consideration the temporal, or sequential, position of the frames. Using the time-series information in addition to the information contained within the image data (such as, pixels) of the frame may increase the robustness of the one or more AI models. For example, for a given video of 5,000 frames, analysis can be performed in such a way that it: a) considers all 5,000 frames sequentially, b) considers a subset of the frames (such as, every other frame, groups of 10 frames or less of more, every 30th frame such that a frame is considered every minute for a video that includes 30 frames per second, or the like), while keeping the order, c) considers a subset of the frames with order being irrelevant (taking advantage of the knowledge that the frames belong to a times-series), or d) considers all frames as individual images, foregoing any temporal information and basing its resulting output on whether one or more features, diseases, or conditions are present in any particular frame. Those frames whose quality has been determined to be sufficient (such as, satisfying one or more thresholds) may be provided to the feature, disease, or condition detection.

In some implementations, one or more frames may undergo the feature, disease, or condition detection provided that the one or more frames have successfully passed the first step of image quality assessment (for instance, the verification that they are of sufficient quality). In some cases, disease, condition, or feature detection may be performed once the video (or live feed) is in focus, within a specific brightness range, absent of artifacts (such as, reflections or blurring), or the like. This verification can be performed before or after any pre-processing (such as, brightness adjustments or the like). For example, once there is a clear, in-focus view of the retina, the AI may automatically start analyzing frames for detection of features, diseases, or conditions. In some cases, if the video or live feed goes out of focus, the analysis for features, diseases, or conditions may cease until the video is back in focus. The image quality assessment that analyzes whether the device is in-focus (or absent of artifacts, etc.) can be separate (such as, separate processing or a module) from the detection of features, disease, or conditions. The image quality assessment that analyzes whether the device is in focus can display or relay information to the user to help improve the focus.

There can be processing or a module (which may be separate from or part of the image quality assessment) that aids in the maintenance of focus or specific video or frame characteristics (such as, brightness, artifacts, etc.). For example, once the retina comes into focus, there can be a software or hardware module that automatically adjusts the focus of the image and/or imaging optics to maintain the focused retinal image. Assessment of the movement during the video recording process can be performed and correction for the motion can be made, for example, by using a machine learning (ML) model that processes the captured images.

An indication can be provided to the user when the video (or frames) is of sufficient quality based on the image quality assessment. The indication can be one or more of visual, audible, tactile, or the like. For example, a green ring (or another indication) may appear around the outside edge of the retinal video feed when the frames (such as, any of the frames from a group of frames or all of the frames from a group of frames) are passing the image quality assessment. In another example, a green dot or other indication, such as text, may appear on a display of the imaging device. The indication can be provided in real-time. An indication can be provided to the user when one or more features, diseases, or conditions are present or the probability for the presence of the features, diseases, or conditions. The indication can be provided in real-time.

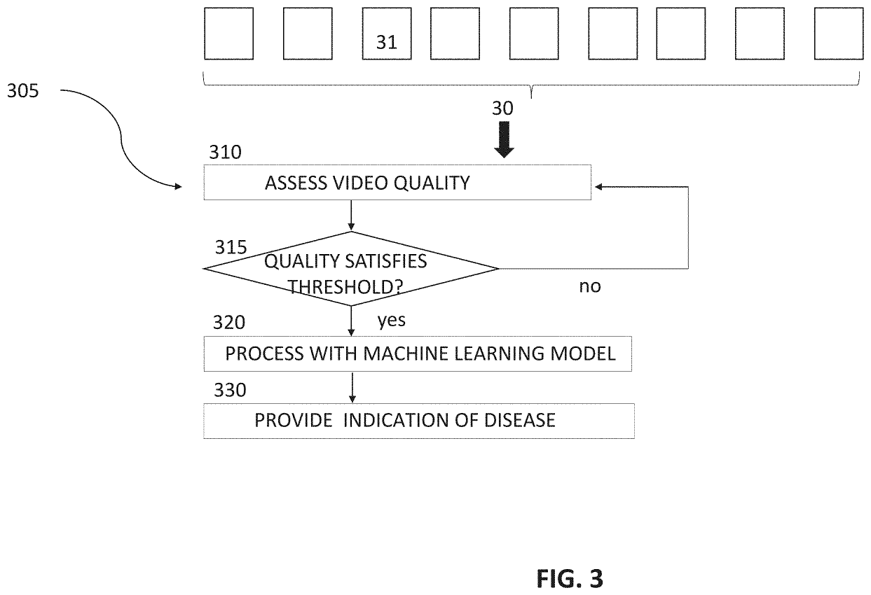

FIG. 3 illustrates a flow chart of a method 305 for image analysis and diagnosis. The method 305 can be implemented during live imaging, such as, during live retinal imaging using the retina camera illustrated in FIG. 1 or FIG. 2. A retinal diagnostics instrument (for example, with the electronics 210 and the image detection system 300) can perform the method 305. A retinal diagnostics instrument (such as, the retina camera illustrated in FIG. 1 and FIG. 2), may capture video data of an eye of a patient by an imaging device (for example, a camera). As shown in FIG. 3, a video 30 can include multiple frames 31.

As shown in FIG. 3, the method 305 may start at block 310 where it assesses a quality of the video data of the eye of the patient. As described herein, the quality can be assessed for each frame in the video data, for a group of frames of interest, or the like. The method 305 can proceed to a decision block 315 to determine whether the quality of the video data (such as, the quality of each frame, quality of the frames of the group of frames, or the like) satisfies at least one threshold. If the quality of the video data does not satisfy the at least one threshold, the method 305 may terminate or start over at block 310 with a different frame 31 or a different portion of video 30.

If the quality of the video data satisfies at least one threshold, the method 305 can proceed to block 320 to process a plurality of images of the eye with at least one machine learning model in order to determine a presence of at least one disease from a plurality of diseases that the at least one machine learning model has been trained to identify. The plurality of images can include those frames whose quality has been determined to satisfy the at least one threshold. The method 305 can proceed to block 330 to provide an indication of the presence of the at least one disease.

The assessment of the quality of the video data of the eye of a patient at block 310 can include determining one or more of image quality of the video data or presence of an anatomical structure of interest in the video data. The assessment of the quality of the video data can include assessment of at least one of: focus, brightness, contrast, presence of one or more aberrations or reflections, or anatomic location. The assessment of the quality of the video data can be based on an assessment of the quality of one or more frames of the video data. The assessment of the quality of the video data can be based on the assessment of quality of a group of frames of the video data. The method 305 may permit capture of image data of the eye without requiring a user to capture the image data. At least one of the video data or the plurality of images can be displayed on a display. The display can provide an indication of the determination that the quality of the video data satisfies the at least one threshold, in connection with the block 315. The display can provide an indication of the presence of the at least one disease, in connection with the block 330. In some embodiments, the display comprises a touch screen display.

### Assessing Video Data Quality

The assessment or determination of the video data quality can be based on individually captured frames, on sequences of captured frames, or any plurality of captured frames.

The image quality may be determined based on the environmental parameters, for example, an image may be captured and the ambient light in the captured image may be evaluated. The image quality may be determined based on the patient's behavior, for example, in the case that the patient blinks, and the like. The image quality may be determined based on the alignment of the camera with the patient's eye, for example, with the patient's line-of-sight, or the like. For instance, the patient should look in a particular direction, the patient should focus on an item which is located at a particular distance relative to the eye, and the like.

The image quality may be determined based on the extraction of the at least one feature of the eye. For instance, the image quality may be determined to be acceptable when a quality metric satisfies (such as, meets or exceeds) a predetermined threshold value, the image may be used, such as, for an eye examination. However, if the image quality does not meet the predetermined criterion, the system may further output information for improving the image quality. The information may be output to the user via the user interface (such as, displayed), as described herein.

Iterative assessment of the video quality can be performed until the image quality of at least one feature of the eye in the captured image meets a predefined criterion (such as, satisfies at least one threshold). The predefined criterion may relate to the image quality, such as, the location of a feature of the eye in the image, ambient light, sharpness of the image, or the like, as described herein, and the iterative process may be performed until the image quality meets the predefined criterion, which may include that the variation of the image quality is small, such as less than a threshold.

One or more captured frames may be assessed for quality and, if the quality is insufficient (such, as less than a threshold), be rejected. For example, rejection of one or more poor quality frames can be performed responsive to one or more of: detecting an artifact (such as, a blur), detecting that the retina is not in a correct location, detecting that the image is too dark, detecting that the image was captured during blinking, or the like. Assessment and rejection can be performed automatically, such as by at least one machine learning model. A set of frames can be analyzed in parallel using the at least one machine learning model. For instance, different frames can be analyzed by parallel neural networks. Parallel processing of the frames can be applicable in cases temporal information is not present or is not important.

The captured image may be analyzed, and the patient's eye may be examined. The examination of the patient's eye may be based on a comparison of the captured image of the patient's eye and a reference image. The reference image may be an image that has been captured in the past, for example an image that has been captured by an ophthalmologist. For example, a patient visits an ophthalmologist, the ophthalmologist captures a high-quality image (such as, high resolution or the like) of the patient's eye, such as, with a specific fundus camera, and stores it as a reference image, the reference image may be captured, for example, by an advanced fundus camera. Moreover, the reference image may be, for example, a high-quality image of the patient's eye that is captured by the camera of a mobile device and stored as a reference image, such as, for examination of the patient's eye.

A plurality of captured images can be analyzed with a trained machine model to assess the quality. The trained model, may be for example, a model which is trained by feeding high-quality images (such as, captured by a doctor with a professional fundus camera) to a machine learning model. The trained model can be trained using supervised or unsupervised methods. The model may process the high-quality images, and hence, the model may be trained to analyze the plurality of captured images, or the like. The model may include parameters which are determined by the machine learning model during training. One or more of the model or its parameters may be stored in the mobile device. The trained model may further determine an image quality of at least one feature of the eye in the captured image, and may further be configured to output information for changing the image quality of the at least one feature of the eye.

The machine learning model may analyze the captured image based on the features analyzed or extracted. The machine learning model may apply an image processing technique, or a pattern recognition technique in which algorithm(s) are used to detect and isolate different features of the eye, or desired portions, in the captured images. The technique might be applied to one or more individual captured images and/or to sequences of captured images and/or to any plurality of captured images.

For example, at least one feature of the eye may be extracted, and the image may be analyzed. The extracted features of the eye may be the retina, the optic disc, the blood vessels in the eye, the optic nerve, location of the pupil for at least one of the eyes, physical dimension of the at least one of the eye's pupils, radii of the pupil in the left and right eye, and the like. Such a machine learning model may be based on at least one of: Scale Invariant Feature Transfer (SIFT), Steerable Filters, Gray Level Co-occurrence Matrix (GLCM), Gabor Features, Tubeness, or the like. The extracted features can include global or local sets of extracted features.

The machine learning model may be based on a classifier technique and the image may be analyzed. Such a machine learning model may be based on least one of: Random Forest; Support Vector Machine; Neural Net, Bayes Net, or the like. Furthermore, the machine learning model may apply deep-learning techniques and the image may be analyzed. Such deep-learning techniques may be based on at least one of: Autoencoders, Generative Adversarial Network, weakly supervised learning, boot-strapping, or the like.

### Assessing Image Quality

As described herein, the general framework for image analysis and disease detection can include: i) selecting a number of frames from the video, ii) assessing the quality of the frames and pass those meeting a standard of quality through, iii) extracting features relevant for disease detection, and iv) determining the presence or absence of disease.

In many applications of eye disease determination, a single image frame is used to assess the prediction of disease. Using video, one can perform effective sampling methods to select several image frames that are of the same point of view or different points of view. Several approaches to image quality assessment utilizing machine learning can be used.

Several approaches to frame selection can be used. For example, all frames can be passed through to an image quality assessment (IQA) model, which can be a machine learning model (such as, one or more support vector machines, filter banks, or lightweight neural networks). To facilitate real-time image capture and analysis, a lightweight IQA model can be used to pass all frames in real-time. A lightweight model may require minimal processing for inference. For example, a lightweight model can include one or more of a MobileNet or a model that has been designed for fast processing (such as, a model that has undergone weight quantization or layer pruning).

Another approach to frame selection is to uniformly sample. For example, if a video contains 1,000 frames, one may uniformly sample 100 or 10% of the frames and pass them through the IQA model. For the frames that pass and meet the desired level of quality, several adjacent frames can be sampled, thereby likely increasing the number of frames meeting the quality threshold.

There are several approaches to image and video quality assessment. One relevant approach for retinal image and quality assessment is known as no reference video quality assessment (NR-VQA) or no reference image quality assessment (NR-IQA). In NR-VQA and NR-IQA, image quality can be assessed without knowledge of the distortions present and without access to the undistorted version of the image. Several models can be used for NR-VQA and NR-IQA. In some implementations, one may use a collection of hand-derived filter banks based on a wavelet transform, Fourier transform, or Discrete Cosine transform. These filter banks can perform convolutions to extract features of the image. Features can be extracted using a Gray-level co-occurrence matrix, SIFT features, Gabor features, steerable filters, or the like. In some instances, one may use a convolutional neural network (CNN) to extract features from an image or frames of a video. The CNN may be trained from scratch using a dataset of retinal images of good and poor quality or trained using transfer learning on a large model trained on a set of natural scene images (for example, using a ResNet or Inception-Net). In transfer learning, one or many final layers of the CNN can be re-trained using a dataset of retinal images. In some cases, one may use models designed to determine the presence of retinal features, such as the optical disk or vessels. In certain implementations, one may use the histogram of the image as the set of features.

After features are extracted from the image or frames of the image, the features can be passed to one or more classifiers (such as a neural network, support vector machine, random forest, or logistic regression) to output a quality score. The one or more classifiers can be trained using a dataset of good and poor-quality retinal images. These can be obtained from real patient data or artificially created by altering good quality images with random distortion patterns, such as blur, noise, saturation, darkening, or the like.

Temporal information from the video sequence can be incorporated into the IQA model using a machine learning model that incorporates time, for example a recurrent neural network (RNN) or a long-short term memory (LSTM) network. NR-VQA can be performed by passing the extracted features to an RNN, an LSTM, or a Transformer to model dependencies between consecutive frames and assign an image quality score. After a sufficient number of good quality frames are extracted from the video, the frames can be passed for feature extraction and disease detection.

### Determination of Presence of Disease Based on Video Data

Current standards for disease detection are based on one or a small number of retinal images. Combining several frames of a video for disease detection can improve reliability and accuracy of results. Using several frames from one or more viewing angles can improve the field of view for observing additional biomarkers of disease and can enable selecting only high-quality images for detection.

Several approaches can be used to enable disease detection from video frames. In some cases, a machine learning-based classifier can be used (such as, a CNN, a SVM, random forests, or a logistic regression model). The machine learning-based classifier can take as input either i) a raw image, ii) a processed image, or iii) a set of features extracted automatically. The machine learning-based classifier can then output a disease severity score, for example “0” for no disease, “1” for mild disease, “2” for moderate disease, “3” for severe disease, and “4” for vision threatening disease. Additionally or alternatively, the output can include a probabilistic score that indicates the probability of disease (in some cases, provided proper calibration has been performed). The machine learning-based classifier can be trained using supervised or semi-supervised approaches.

A CNN-based classifier can be trained from scratch, using a dataset of retinal images. A CNN-based model additionally or alternatively can be trained using transfer learning and fine tuning. In this approach, an existing neural network, such as a ResNet trained on a set of natural images is taken and modified. The modification is done by re-training one or more final convolution layers on a dataset of retinal images.

The classifier can be trained and processed using video frames in several ways. Each video frame deemed sufficient quality can be processed independently. Several frames can be passed to the classifier model together, without temporal information. The classifier model can be combined with an LSTM, RNN, or Transformer to incorporate temporal information when predicting the presence of disease. This can enable processing of frames in order and incorporating information and features from previous frames.

Models containing temporal information can use techniques such as optical flow to observe changes in the image over time, for example flow through the vessels. Such dynamic information can aid the machine learning classifiers by providing additional potential disease biomarkers.

A more accurate and reliable disease prediction can be achieved by combining several frames. For example, if 10 video frames are passed, and the classifier outputs for 50% of the frames a score of 1 (mild disease), for 20% of the frames a score of 3 (severe disease), and for 30% of the frames a score of 0 (no disease), one can output the final diagnosis using worst case, best case, average case, or median case. For example, in the worst case, the patient would be deemed to have a score of 3 (severe disease). In the average case, the score can be 1.1 (which can be rounded down to 1) for mild disease. In the best case, the score can be 0 (no disease). A measure of uncertainty can also be derived from multiple predictions, for example, by reporting the standard deviation or variance of the scores. The probability of each prediction can also be combined to give a measure of uncertainty. A level of uncertainty can affect the downstream clinical flow (for example, requiring a second opinion or visit by a specialist).

### Additional Examples

Example 1: A retinal diagnostics instrument comprising:

a housing;

an imaging device supported by the housing, the imaging device configured to capture video data of an eye of a patient; and

an electronic processing circuitry supported by the housing, the electronic processing circuitry configured to:

assess a quality of the video data of the eye of the patient;

based on a determination that the quality of the video data satisfies at least one threshold, process a plurality of images of the eye obtained from the video data with at least one machine learning model to determine a presence of at least one disease from a plurality of diseases that the at least one machine learning model has been trained to identify; and

provide an indication of the presence of the at least one disease.

Example 2: The instrument of any of the preceding examples, wherein the plurality of images of the eye of the patient are processed without requiring a user to capture the plurality of images.
Example 3: The instrument of any of the preceding examples, wherein the electronic processing circuitry is configured to assess the quality of the video data based on an assessment of quality of one or more frames of the video data.
Example 4: The instrument of example 3, wherein the electronic processing circuitry is configured to assess the quality of the video data based on the assessment of quality of a group of frames of the video data, and wherein the plurality of images comprises one or more frames of the group of frames whose quality had been determined to satisfy the at least one threshold.
Example 5: The instrument of example 4, wherein the electronic processing circuitry is configured to assess the quality of the video data based on the assessment of each frame of the group of frames of the video data, and wherein the plurality of images comprises one or more frames whose quality had been determined to satisfy the at least one threshold.
Example 6: The instrument of example 4, wherein the group of frames includes frames that have been uniformly sampled from a plurality of frames of the video data.
Example 7: The instrument of example 4, wherein the indication of presence of the at least one disease includes a measure of uncertainty determined from the one or more frames of the group of frames whose quality had been determined to satisfy the at least one threshold.
Example 8: The instrument of any of the preceding examples, further comprising a display at least partially supported by the housing, and wherein the electronic processing circuitry is configured to cause the display to display at least one of the video data or the plurality of images.
Example 9: The instrument of example 8, wherein the electronic processing circuitry is configured to cause the display to display an indication of the determination that the quality of the video data satisfies the at least one threshold.
Example 10: The instrument of any of examples 8 to 9, wherein the electronic processing circuitry is further configured to cause the display to provide an indication of the presence of the at least one disease.
Example 11: The instrument of any of examples 8 to 10, wherein the display comprises a touch screen display.
Example 12: The instrument of any of the preceding examples, wherein assessment of the quality of the video data of the eye of the patient comprises determining one or more of image quality of the video data or presence of an anatomical structure of interest in the video data.
Example 13: The instrument of example 12, wherein the assessment of the image quality of the video data comprises assessment of at least one of: focus, brightness, contrast, presence of one or more aberrations or reflections, or anatomic location.
Example 14: The instrument of any of the preceding examples, wherein the imaging device comprises a camera.
Example 15: The instrument of any of the preceding examples, further comprising a cup positioned at a distal end of the housing, the cup configured to be an interface between instrument and the eye of the patient.
Example 16: The instrument of example 15, wherein the cup is disposable.
Example 17: The instrument of any of the preceding examples, wherein the housing comprises a body and a handle connected to the body and configured to be held by a user.
Example 18: The instrument of any of the preceding examples, wherein the housing is portable.
Example 19: A method of operating a retinal diagnostics instrument, the method comprising: by an electronic processing circuitry of the retinal diagnostics instrument:

assessing a quality of a video data of an eye of a patient;

based on determining that the quality of the video data satisfies at least one threshold, processing a plurality of images of the eye obtained from the video data with at least one machine learning model to determine a presence of at least one disease from a plurality of diseases that the at least one machine learning model has been trained to identify; and

providing an indication of the presence of the at least one disease.

Example 20: The method of example 19, wherein the plurality of images of the eye of the patient are processed without requiring a user to capture the plurality of images.
Example 21: The method of any of examples 19 to 20, wherein assessing the quality of the video data is based on assessing a quality of one or more frames of the video data.
Example 22: The method of example 21, further comprising assessing a quality of a group of frames of the video data, wherein the plurality of images comprises one or more frames of the group of frames whose quality had been determined to satisfy the at least one threshold.
Example 23: The method of example 22, further comprising assessing a quality of each frame of the group of frames of the video data, wherein the plurality of images comprises one or more frames whose quality had been determined to satisfy the at least one threshold.
Example 24: The method of example 22, wherein the group of frames includes frames that have been uniformly sampled from a plurality of frames of the video data.
Example 25: The method of example 22, wherein the indication of presence of the at least one disease includes a measure of uncertainty determined from the one or more frames of the group of frames whose quality had been determined to satisfy the at least one threshold.

### Other Variations

Although the foregoing provides one or more examples of live image or video analysis on a retina camera, disclosed systems, devices, and methods are not limited to retina cameras, but can be extended to any diagnostics device, such as an otoscope, dermatology scope, or the like. Although the foregoing provides one or more examples of a portable medical diagnostics device, the approaches disclosed herein can be utilized by non-portable (such as, table top) diagnostics devices.

Although the foregoing provides one or more examples of live image or video analysis on-board, disclosed systems, devices, and methods are not so limited and can be utilized by cloud-based systems, particularly in situations where reliable network connectivity is available.

Example implementations are described with reference to classification of the eye tissue, but the techniques may also be applied to the classification of other tissue types. More specifically, the approach of visualizing the effects of multiple different tissue segmentations as an aid for the user to understand their effects, and hence to gain insight into the underlying explanation for the output classification, is generally applicable to many different tissue regions and types. For example, X-ray, ultrasound or MM images all produce 2D or 3D images of regions of the body, and it will be apparent that the image segmentation neural network described may be used to segment different tissue types from such images. The segmented region may then be analyzed by the classification neural network to classify the image data, for example identify one or more pathologies and/or determine one or more clinical referral decisions. Other implementations of the system may be used for screening for other pathologies in other body regions.

Any of the transmission of data described herein can be performed securely. For example, one or more of encryption, https protocol, secure VPN connection, error checking, confirmation of delivery, or the like can be utilized.

The design may vary as components may be added, removed, or modified. Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The various illustrative logical blocks, modules, routines, and algorithm steps described in connection with the embodiments disclosed herein can be implemented as electronic hardware, or combinations of electronic hardware and computer software. To clearly illustrate this interchangeability of hardware and software, various illustrative components, blocks, modules, and steps have been described above generally in terms of their functionality. Whether such functionality is implemented as hardware, or as software that runs on hardware, depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a general purpose processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor device can be a microprocessor, but in the alternative, the processor device can be a controller, microcontroller, or state machine, combinations of the same, or the like. A processor device can include electronic circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An example storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, or within less than 0.01% of the stated amount.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

What is claimed is:

1. A retinal diagnostics instrument comprising:
a housing;
an imaging device supported by the housing, the imaging device configured to capture video data of an eye of a patient; and
an electronic processing circuitry supported by the housing, the electronic processing circuitry configured to:
assess a quality of the video data of the eye of the patient;
based on a determination that the quality of the video data satisfies at least one threshold, process a plurality of images of the eye obtained from the video data with at least one machine learning model to determine a presence of at least one disease from a plurality of diseases that the at least one machine learning model has been trained to identify; and
provide an indication of the presence of the at least one disease.

2. The instrument of claim 1, wherein the plurality of images of the eye of the patient are processed without requiring a user to capture the plurality of images.

3. The instrument of claim 1, wherein the electronic processing circuitry is configured to assess the quality of the video data based on an assessment of quality of one or more frames of the video data.

4. The instrument of claim 3, wherein the electronic processing circuitry is configured to assess the quality of the video data based on the assessment of quality of a group of frames of the video data, and wherein the plurality of images comprises one or more frames of the group of frames whose quality had been determined to satisfy the at least one threshold.

5. The instrument of claim 4, wherein the electronic processing circuitry is configured to assess the quality of the video data based on the assessment of each frame of the group of frames of the video data, and wherein the plurality of images comprises one or more frames whose quality had been determined to satisfy the at least one threshold.

6. The instrument of claim 4, wherein the group of frames includes frames that have been uniformly sampled from a plurality of frames of the video data.

7. The instrument of claim 4, wherein the indication of presence of the at least one disease includes a measure of uncertainty determined from the one or more frames of the group of frames whose quality had been determined to satisfy the at least one threshold.

8. The instrument of claim 1, further comprising a display at least partially supported by the housing, and wherein the electronic processing circuitry is configured to cause the display to display at least one of the video data or the plurality of images.

9. The instrument of claim 8, wherein the electronic processing circuitry is configured to cause the display to display an indication of the determination that the quality of the video data satisfies the at least one threshold.

10. The instrument of claim 8, wherein the electronic processing circuitry is further configured to cause the display to provide an indication of the presence of the at least one disease.

11. The instrument of claim 1, wherein assessment of the quality of the video data of the eye of the patient comprises determining one or more of image quality of the video data or presence of an anatomical structure of interest in the video data.

12. The instrument of claim 11, wherein the assessment of the image quality of the video data comprises assessment of at least one of: focus, brightness, contrast, presence of one or more aberrations or reflections, or anatomic location.

13. The instrument of claim 1, further comprising a cup positioned at a distal end of the housing, the cup configured to be an interface between instrument and the eye of the patient.

14. The instrument of claim 1, wherein the housing is portable, and wherein the housing comprises a body and a handle connected to the body and configured to be held by a user.

15. A method of operating a retinal diagnostics instrument, the method comprising:
by an electronic processing circuitry of the retinal diagnostics instrument:
assessing a quality of a video data of an eye of a patient;
based on determining that the quality of the video data satisfies at least one threshold, processing a plurality of images of the eye obtained from the video data with at least one machine learning model to determine a presence of at least one disease from a plurality of diseases that the at least one machine learning model has been trained to identify; and
providing an indication of the presence of the at least one disease.

16. The method of claim 15, wherein the plurality of images of the eye of the patient are processed without requiring a user to capture the plurality of images.

17. The method of claim 15, wherein assessing the quality of the video data is based on assessing a quality of one or more frames of the video data.

18. The method of claim 17, further comprising assessing a quality of a group of frames of the video data, wherein the plurality of images comprises one or more frames of the group of frames whose quality had been determined to satisfy the at least one threshold.

19. The method of claim 18, further comprising assessing a quality of each frame of the group of frames of the video data, wherein the plurality of images comprises one or more frames whose quality had been determined to satisfy the at least one threshold.

20. The method of claim 18, wherein the group of frames includes frames that have been uniformly sampled from a plurality of frames of the video data.

21. The method of claim 18, wherein the indication of presence of the at least one disease includes a measure of uncertainty determined from the one or more frames of the group of frames whose quality had been determined to satisfy the at least one threshold.
